(19) United States
(12) Patent Application Publication
(10) Pub. No.: US 2020/0395782 A1
(43) Pub. Date: Dec. 17, 2020

(54) POWER CONVERSION DEVICE

(71) Applicant: Mitsubishi Electric Corporation, Tokyo (JP)

(72) Inventors: Yutaka KUBOYAMA, Tokyo (JP); Kikuo IZUMI, Tokyo (JP); Takahiro KATO, Tokyo (JP)

(73) Assignee: Mitsubishi Electric Corporation, Tokyo (JP)

(21) Appl. No.: 16/463,243

(22) PCT Filed: Mar. 23, 2018
(86) PCT No.: PCT/JP2018/011611

§ 371 Date: May 22, 2019

(51) Int. Cl. H02J 13/00; H02J 3/18; H02J 3/32; H02J 3/38

(52) U.S. Cl. CPC H02J 13/00036; H02J 3/18; H02J 2300/22; H02J 3/381; H02J 3/32

(57) ABSTRACT

A power conversion device includes: a power converter connected to an electrical storage device that stores direct current power, the power converter being capable of converting the direct current power stored in the electrical storage device to alternating current power and outputting the alternating current power to a power system and to a customer load; and a control unit to control the power converter on a basis of a first active power command value and a first reactive power command value provided from an external controller, of a power consumption of the customer load, of a current root-mean-square value of a power flow current supplied to the power system, and a current upper limit that is set on a basis of a rated current of a molded case circuit breaker connected between the power converter and the power system.

### FIELD

The present invention relates to a power conversion device capable of converting direct current (DC) power stored in an electrical storage device to alternating current (AC) power and outputting the AC power to a power system.

### BACKGROUND

A power conversion device is conventionally known that converts DC power stored in an electrical storage device to AC power and outputs the AC power to a power system (see, e.g., Patent Literature 1). Patent Literature 1 discloses a power conversion device including a charge-discharge control unit that controls charging and discharging of an electrical storage device connected to a power system on the basis of a system voltage value of the power system and an output power value of a photovoltaic power generation apparatus connected to the power system.

The charge-discharge control unit includes a total output upper limit determination unit that sets a total output upper limit of a combination of the photovoltaic power generation apparatus and the electrical storage device to a fixed value when the system voltage value is less than a threshold and that reduces the total output upper limit with an increase of the system voltage value from a value at or above the threshold. The charge-discharge control unit also includes a charge-discharge command value computation unit that calculates a charge-discharge command value of the electrical storage device on the basis of the total output upper limit and an output power value of the photovoltaic power generation apparatus. The power conversion device disclosed in Patent Literature 1 includes a reactive power control unit that controls reactive power supplied to the power system on the basis of the system voltage value and the charge-discharge command value.

### CITATION LIST

### Patent Literature

Patent Literature 1: Japanese Patent Application Laid-open No. 2013-165593

### SUMMARY

### Technical Problem

To control a power flow in consideration of the entire power system, the power conversion device disclosed in Patent Literature 1 may control the power output by the power conversion device on the basis of an active power command value and a reactive power command value provided from an external controller disposed outside the power conversion device. However, if a molded case circuit breaker is connected between the power conversion device and the power system, the external controller, unaware of performance of the molded case circuit breaker, presents a problem in that the current flowing into the molded case circuit breaker may exceed the rated current, thereby causing the overcurrent protection function to open the molded case circuit breaker.

The present invention has been made in view of the foregoing, and it is an object of the present invention to provide a power conversion device capable of outputting electrical power such that opening of a molded case circuit breaker connected between the power conversion device and a power system is prevented even when the power conversion device operates on the basis of an active power command value and a reactive power command value provided externally to the power conversion device.

### Solution to Problem

In order to solve the above-described problems and achieve the object, a power conversion device according to an aspect of the present invention includes: a power converter connected to an electrical storage device that stores direct current power, the power converter being capable of converting the direct current power stored in the electrical storage device to alternating current power and outputting the alternating current power to a power system and to a customer load; and a control unit to control the power converter on a basis of a first active power command value and a first reactive power command value provided from an external controller, of a power consumption of the customer load, of a current root-mean-square value of a power flow current supplied to the power system, and a current upper limit that is set on a basis of a rated current of a molded case circuit breaker connected between the power converter and the power system.

### Advantageous Effects of Invention

A power conversion device according to the present invention provides an advantage in that electrical power can be output such that opening of a molded case circuit breaker connected between the power conversion device and a power system is prevented even when the power conversion device operates on the basis of an active power command value and a reactive power command value provided externally to the power conversion device.

### BRIEF DESCRIPTION OF DRAWINGS

FIG. 1 is a diagram illustrating a configuration of a power conversion device according to a first embodiment of the present invention.

FIG. 2 is a diagram illustrating a first example of waveforms of a voltage and of a current related to a power flow and waveforms of the power flow output by the power conversion device illustrated in FIG. 1.

FIG. 3 is a diagram illustrating a second example of waveforms of the voltage and of the current related to the power flow and waveforms of the power flow output by the power conversion device illustrated in FIG. 1.

FIG. 4 is a diagram illustrating a third example of waveforms of the voltage and of the current related to the power flow and waveforms of the power flow output by the power conversion device illustrated in FIG. 1.

FIG. 5 is a flowchart illustrating an operation of correction of a first active power command value and a first reactive power command value performed by the control unit illustrated in FIG. 1.

FIG. 6 is a diagram illustrating a processing circuit for implementing at least part of the function of the detection unit and of the control unit included in the power conversion device illustrated in FIG. 1.

FIG. 7 is a diagram illustrating a processor for implementing at least part of the function of the detection unit and of the control unit included in the power conversion device illustrated in FIG. 1.

FIG. 8 is a diagram illustrating a configuration of a power conversion device according to a second embodiment of the present invention.

### DESCRIPTION OF EMBODIMENTS

A power conversion device according to embodiments of the present invention will be described in detail below with reference to the drawings. Note that these embodiments are not intended to limit the scope of this invention.

### First Embodiment.

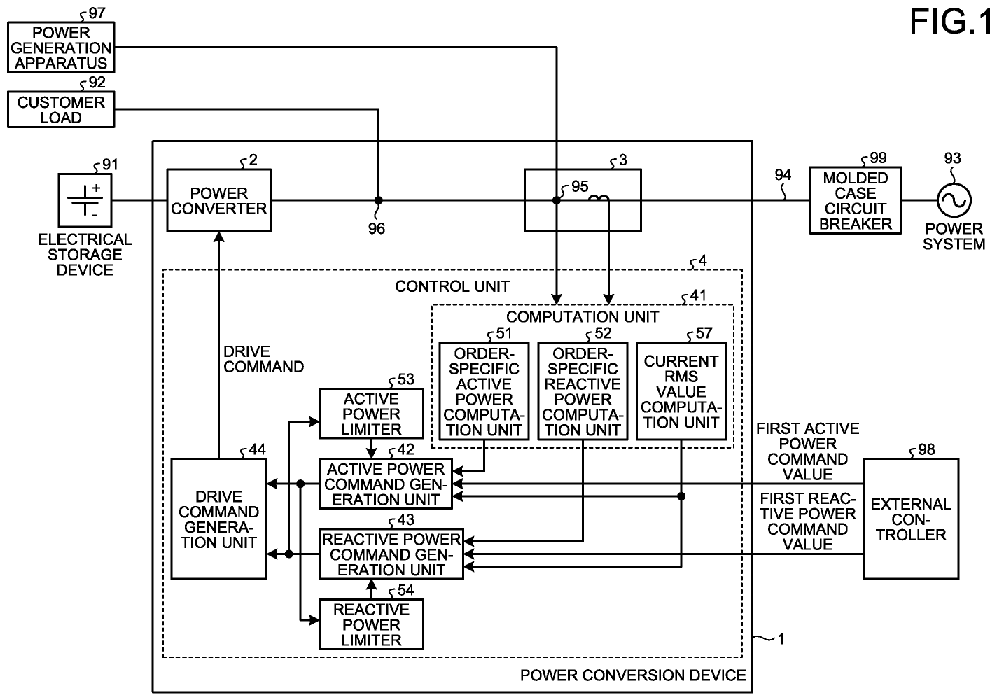

FIG. 1 is a diagram illustrating a configuration of a power conversion device 1 according to a first embodiment of the present invention. The power conversion device 1 is a device installed in a facility such as a residence and is a device having a function to convert DC power stored in an electrical storage device 91 that stores DC power to AC power and to output the AC power to a customer load 92 and a power system 93. FIG. 1 also illustrates the electrical storage device 91, the customer load 92, and the power system 93. The customer load 92 is an electric appliance that consumes electricity, such as an air conditioner, a refrigerator, or a lighting device.

The power conversion device 1 includes a power converter 2, a detection unit 3, and a control unit 4. The power converter 2 is connected to the electrical storage device 91, and it has a function to convert DC power stored in the electrical storage device 91 to AC power and also has a function to output the AC power to the customer load 92 and the power system 93. For example, the power converter 2 includes an inverter circuit. The detection unit 3 detects a voltage value and a current value of a power flow current at a first location 95 of a power line 94 connecting together the power converter 2 and the power system 93 so as to calculate a value of the power flow supplied from the power converter 2 to the power system 93 through a molded case circuit breaker 99. The control unit 4 generates a drive command for controlling the power converter 2 on the basis of a detection result of the detection unit 3.

The customer load 92 is connected to the power line 94. The power line 94 is connected to the molded case circuit breaker 99. The molded case circuit breaker 99 is connected to the power system 93. The customer load 92 is connected to a second location 96 of the power line 94 located between the power converter 2 and the first location 95. The power converter 2 operates on the basis of a drive command generated by the control unit 4. A power generation apparatus 97 that outputs AC power is connected to the first location 95. FIG. 1 also illustrates the power generation apparatus 97. The power generation apparatus 97 generates DC power by means of solar power generation, converts the generated DC power to AC power, and supplies the AC power produced by the conversion to the power line 94. Note that the power generation apparatus 97 may not necessarily be connected to the first location 95.

The control unit 4 includes a computation unit 41, an active power command generation unit 42, a reactive power command generation unit 43, a drive command generation unit 44, an active power limiter 53, and a reactive power limiter 54.

The computation unit 41 calculates an active power value, a reactive power value, and a current root-mean-square (RMS) value of the power flow current on the basis of the detection result of the detection unit 3. Specifically, the computation unit 41 includes an order-specific active power computation unit 51, an order-specific reactive power computation unit 52, and a current RMS value computation unit 57.

The order-specific active power computation unit 51 is a first active power computation unit that calculates an active power value of the power flow on the basis of the voltage and the current detected by the detection unit 3. Specifically, the order-specific active power computation unit 51 calculates the active power value for the frequency of the AC power of the power system 93 and calculates the active power value or values (hereinafter referred to simply as value/values) for one or more multiplied frequencies based on the frequency described above. As used herein, the frequency of the AC power of the power system 93 may be referred to as a reference frequency. The order-specific reactive power computation unit 52 is a first reactive power computation unit that calculates a reactive power value of the power flow on the basis of the voltage and the current detected by the detection unit 3. Specifically, the order-specific reactive power computation unit 52 calculates the reactive power value for the reference frequency and calculates the reactive power value/values for one or more multiplied frequencies based on the reference frequency. The current RMS value computation unit 57 calculates the current RMS value of the power flow on the basis of the current detected by the detection unit 3.

The active power command generation unit 42 generates a second active power command value on the basis of a first active power command value provided from an external controller 98 disposed outside the power conversion device 1 and of the active power value/values and the current RMS value calculated by the computation unit 41. The external controller 98 is a device that supplies the first active power command value and a first reactive power command value, which are command values for controlling the power converter 2, to the power conversion device 1, and it can generate command values for controlling the power converter 2 in consideration of the entire power system 93. The second active power command value generated by the active power command generation unit 42 is used for forcing the power flow to follow the first active power command value.

The active power command generation unit 42 generates the second active power command value on the basis of the first active power command value provided from the external controller 98 and of at least one of the active power value for the reference frequency and the active power value/values for the multiplied frequency or frequencies (hereinafter referred to simply as frequency/frequencies) calculated by the order-specific active power computation unit 51. Specifically, the active power command generation unit 42 subtracts, from the first active power command value, the active power value for the reference frequency and the active power value/values for the one or more multiplied frequencies calculated by the order-specific active power computation unit 51 to calculate a deviation for each order, provides control, such as proportional-integral (PI) control, for each order to reduce this deviation, and thus generates the second active power command value.

The active power command generation unit 42 may generate the foregoing second active power command value on the basis of the first active power command value and the active power value for the reference frequency calculated by the order-specific active power computation unit 51. Specifically, the active power command generation unit 42 may subtract, from the first active power command value, the active power value for the reference frequency calculated by the order-specific active power computation unit 51 to calculate the deviation for each order, provide control, such as PI control, for each order to reduce this deviation, and thus generate the second active power command value.

The active power command generation unit 42 is capable of correcting the first active power command value when the current RMS value calculated by the computation unit 41 exceeds a current upper limit that has been set on the basis of a factor such as the rated current of the molded case circuit breaker 99. For example, the active power command generation unit 42 is capable of correcting the first active power command value on the basis of the active power values, the reactive power values, and the current RMS value calculated by the computation unit 41. In this operation, the active power command generation unit 42 reduces the absolute value of the first active power command value. In a case in which the first active power command value is corrected, the active power command generation unit 42 uses the first active power command value after the correction to generate the second active power command value. The active power command generation unit 42 outputs the generated second active power command value to the drive command generation unit 44.

The reactive power command generation unit 43 generates a second reactive power command value on the basis of the first reactive power command value provided from the external controller 98 and of the reactive power value/values and the current RMS value calculated by the computation unit 41. The second reactive power command value generated by the reactive power command generation unit 43 is used for forcing the power flow to follow the first reactive power command value.

The reactive power command generation unit 43 generates the second reactive power command value on the basis of the first reactive power command value provided from the external controller 98 and of at least one of the reactive power value for the reference frequency and the reactive power value/values for the multiplied frequency/frequencies calculated by the order-specific reactive power computation unit 52. Specifically, the reactive power command generation unit 43 subtracts, from the first reactive power command value, the reactive power value for the reference frequency and the reactive power value/values for the one or more multiplied frequencies calculated by the order-specific reactive power computation unit 52 to calculate a deviation for each order, provides control, such as PI control, for each order to reduce this deviation, and thus generates the second reactive power command value.

The reactive power command generation unit 43 may generate the foregoing second reactive power command value on the basis of the first reactive power command value and the reactive power value for the reference frequency calculated by the order-specific reactive power computation unit 52. Specifically, the reactive power command generation unit 43 may subtract, from the first reactive power command value, the active power value for the reference frequency calculated by the order-specific reactive power computation unit 52 to calculate the deviation for each order, provide control, such as PI control, for each order to reduce this deviation, and thus generate the second reactive power command value.

The reactive power command generation unit 43 is capable of correcting the first reactive power command value when the current RMS value calculated by the computation unit 41 exceeds a current upper limit that has been set on the basis of a factor such as the rated current of the molded case circuit breaker 99. For example, the reactive power command generation unit 43 is capable of correcting the first reactive power command value on the basis of the active power values, the reactive power values, and the current RMS value calculated by the computation unit 41. In this operation, the reactive power command generation unit 43 reduces the absolute value of the first reactive power command value. In a case in which the first reactive power command value is corrected, the reactive power command generation unit 43 uses the first reactive power command value after the correction to generate the second reactive power command value. The reactive power command generation unit 43 outputs the generated second reactive power command value to the drive command generation unit 44.

The active power limiter 53 sets an upper limit of the second active power command value on the basis of the first reactive power command value and an upper limit of the apparent power that can be output by the power converter 2. The active power command generation unit 42 generates the second active power command value that is less than or equal to the upper limit that has been set by the active power limiter 53.

The reactive power limiter 54 sets an upper limit of the second reactive power command value on the basis of the first active power command value and the upper limit of the apparent power described above. The reactive power command generation unit 43 generates the second reactive power command value that is less than or equal to the upper limit that has been set by the reactive power limiter 54.

The drive command generation unit 44 generates a drive command for controlling the power converter 2 on the basis of the second active power command value output by the active power command generation unit 42 and the second reactive power command value output by the reactive power command generation unit 43. Specifically, the drive command generation unit 44 adds the second reactive power command value to the second active power command value to generate the drive command.

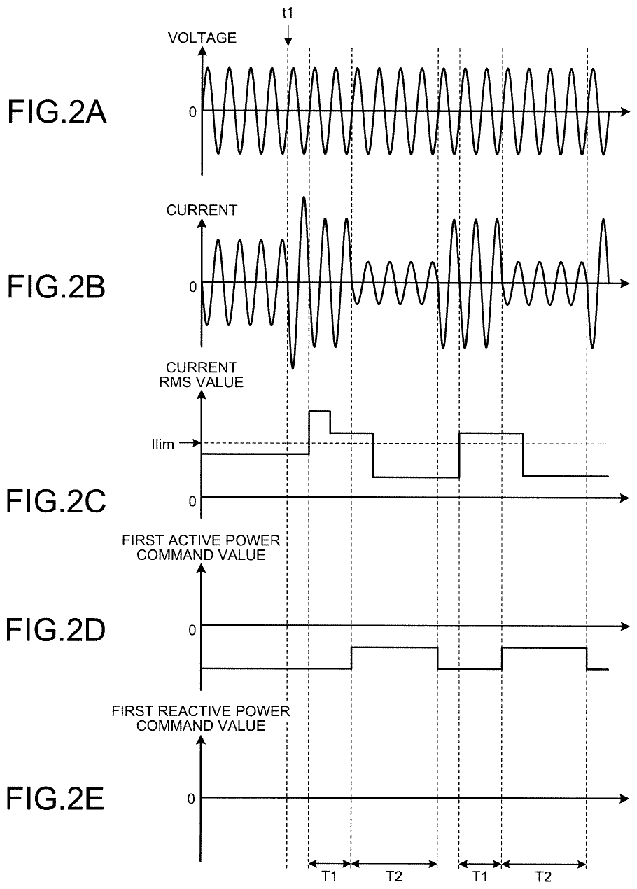

An operation of the power conversion device 1 will next be described. That is, a power flow control method performed by the power conversion device 1 will be described. FIG. 2 is a diagram illustrating a first example of waveforms of a voltage and of a current related to a power flow and waveforms of the power flow output by the power conversion device 1 illustrated in FIG. 1. FIG. 2 illustrates an example of waveforms of the voltage and of the current related to the power flow and waveforms of the power flow under a condition in which the customer load 92 is a resistive load and in which the customer load 92 is connected to the power converter 2 of the power conversion device 1 according to the first embodiment. A power flow control method when the customer load 92 has been connected to the power converter 2 will be described below with reference to FIG. 2. Time t1 illustrated in FIG. 2 indicates the time of load application when the customer load 92 is connected to the power converter 2.

FIG. 2 is a diagram illustrating an example of waveforms of the voltage and of the current related to the power flow and waveforms of the power flow under a condition in which the active power command value provided from the external controller 98 is not 0 W, the reactive power command value is 0 Var, the customer load 92 is a resistive load, and the customer load 92 is connected to the power converter 2 of the power conversion device 1 according to the first embodiment. An active power control method will now be described with reference to FIG. 2. In FIG. 2, the polarity of the current is defined such that the current flow in a direction from the power converter 2 and from the power generation apparatus 97 to the power system 93 is positive. The polarity of active power is defined such that the direction of discharging from the power converter 2 and from the power generation apparatus 97 to the power system 93 is positive. The direction of discharging is the direction of selling electric power. The polarity of reactive power is defined such that the direction of discharging phase-advanced reactive power from the power converter 2 and from the power generation apparatus 97 to the power system 93 is positive.

FIG. 2(a) is a diagram illustrating a waveform of the voltage detected by the detection unit 3. FIG. 2(b) is a diagram illustrating a waveform of the current detected by the detection unit 3. FIG. 2(c) is a diagram illustrating the RMS value of the current of FIG. 2(b). FIG. 2(d) is a diagram illustrating the first active power command value calculated by the active power command generation unit 42. FIG. 2(e) is a diagram illustrating the first reactive power command value calculated by the reactive power command generation unit 43. The first active power command value illustrated in FIG. 2(d) and the first reactive power command value illustrated in FIG. 2(e) are corrected values when the current RMS value has exceeded the current upper limit. As illustrated in FIG. 2(b), upon connection of the customer load 92 to the power converter 2, the active power for the reference frequency increases in the negative direction, that is, in the direction of purchasing electric power. In this situation, for example, in a case in which a portion of the customer load 92 is connected to one phase of a single-phase three-wire system, phase currents may be unbalanced, and the current RMS value may exceed a current value calculated by simply dividing the first active power command value provided from the external controller 98 by the voltage RMS value.

Upon exceeding of the current upper limit by the current RMS value calculated by the computation unit 41, the active power command generation unit 42 corrects the first active power command value to reduce the absolute value of the first active power command value to less than the value provided from the external controller 98, thus to reduce the current RMS value. In this operation, the active power command generation unit 42 calculates the first active power command value such that the average value of the current RMS value is less than or equal to the current upper limit, where the above average value is an average value of the current RMS value over a detection period T1 in which the current RMS value exceeds the current upper limit and over a mitigation period T2 in which the absolute value of the active power command value is set to a reduced value.

The order-specific active power computation unit 51 calculates, on the basis of the voltage and the current detected by the detection unit 3, the active power value for the reference frequency that varies due to connection of the customer load 92 to the power converter 2. The order-specific active power computation unit 51 calculates the active power value for the reference frequency, including the polarity thereof. For example, the order-specific active power computation unit 51 calculates the active power value for the reference frequency, including the polarity thereof that indicates a discharging or charging state. Similarly, the order-specific active power computation unit 51 calculates the active power value/values, including the polarity thereof, for the one or more multiplied frequencies.

Specifically, the order-specific active power computation unit 51 calculates the active power value for the reference frequency and the active power value/values for the one or more multiplied frequencies by performing Fourier transform on each of the voltage detected by the detection unit 3 and the current detected by the detection unit 3 or by applying a filtering operation to attenuate values in a band other than a specific frequency band.

The upper limit of the multiplied frequencies is determined, for example, by a detection characteristic of the detection unit 3 or by a power output characteristic of the power converter 2. The detection characteristic of the detection unit 3 is a characteristic relating to, for example, accuracy or time for detection. The power output characteristic of the power converter 2 is a characteristic relating to, for example, accuracy or time for response for the output power. For example, the order-specific active power computation unit 51 calculates active power values for up to the seventh-order multiplied frequency, which is the frequency seven times as high as the reference frequency. The upper limit of the multiplied frequencies may be determined by a characteristic of the customer load 92. For example, in a case in which the customer load 92 is a capacitor compliant to JIS C 61000-3-2, the order-specific active power computation unit 51 calculates the active power values for up to the thirteenth-order multiplied frequency, which is the frequency 13 times as high as the reference frequency.

The active power command generation unit 42 generates the second active power command value for each of the reference frequency and the one or more multiplied frequencies such that the difference between each of the active power value for the reference frequency and the active power value/values for the one or more multiplied frequencies calculated by the order-specific active power computation unit 51 and the first active power command value provided from the external controller 98 is reduced. The active power command generation unit 42 may receive the first active power command value from the external controller 98 for each of the reference frequency and the one or more multiplied frequencies. The active power command generation unit 42 may determine that the first active power command value is zero for frequencies other than a specific frequency, among the first active power command values provided from the external controller 98, and may thus receive only the first active power command value for that specific frequency. One example of the specific frequency is the reference frequency.

The reactive power value for the reference frequency and the reactive power value/values for the multiplied frequency/frequencies are not varying. Thus, the reactive power values calculated by the order-specific reactive power computation unit 52 are 0 Var. Considering that the first reactive power command value is also 0 Var, the second reactive power command value generated by the reactive power command generation unit 43 is 0 Var.

The drive command generation unit 44 generates a drive command on the basis of the second active power command value generated by the active power command generation unit 42 and the second reactive power command value generated by the reactive power command generation unit 43. Specifically, the drive command generation unit 44 adds the second reactive power command value generated by the reactive power command generation unit 43 to the second active power command value generated by the active power command generation unit 42 to generate the drive command. The power converter 2 operates on the basis of the drive command generated by the drive command generation unit 44. Operation of the power converter 2 based on the drive command causes the power output by the power converter 2 to follow the second active power command value generated by the active power command generation unit 42 and the second reactive power command value generated by the reactive power command generation unit 43. The power flow follows the first active power command value and the first reactive power command value provided from the external controller 98, or when the current RMS value has exceeded the current upper limit, follows the first active power command value after the correction and the first reactive power command value after the correction.

Also in a case in which the customer load 92 that is a resistive load is disconnected from the power converter 2 and in a case in which the active power value for the reference frequency of the power generation apparatus 97 has changed, the power flow control method performed by the power conversion device 1 is the same as the power flow control method in the above case described with reference to FIG. 2, in which the customer load 92 that is a resistive load is connected to the power converter 2.

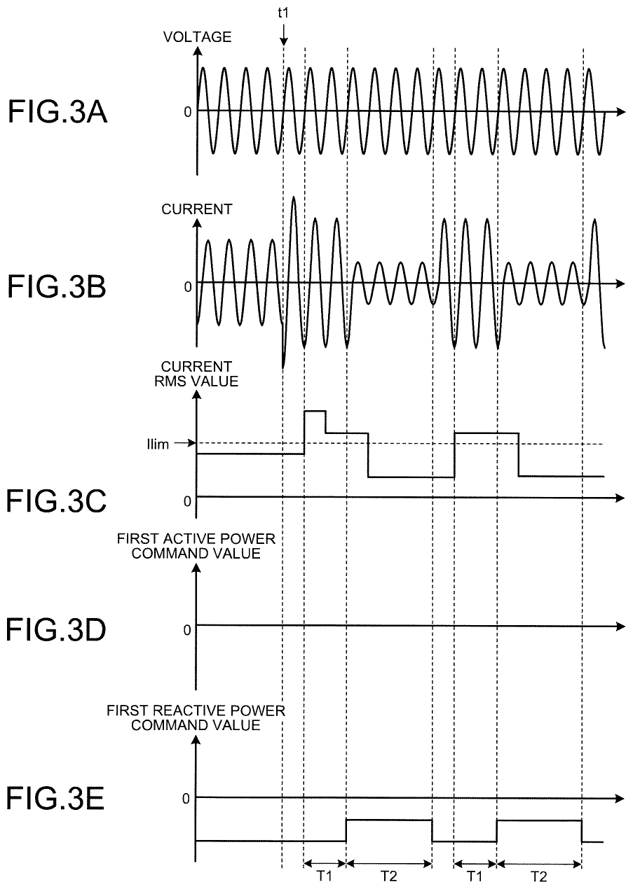

FIG. 3 is a diagram illustrating a second example of waveforms of the voltage and of the current related to the power flow and waveforms of the power flow output by the power conversion device 1 illustrated in FIG. 1. FIG. 3 illustrates an example of waveforms of the voltage and of the current related to the power flow and waveforms of the power flow under a condition in which the reactive power command value provided from the external controller 98 is not 0 Var, the active power command value is 0 W, the customer load 92 is a capacitive load, and the customer load 92 is connected to the power converter 2 of the power conversion device 1 according to the first embodiment. A reactive power control method will be described below with reference to FIG. 3. Time t1 illustrated in FIG. 3 indicates the time of load application when the customer load 92 is connected to the power converter 2.

FIG. 3(a) is a diagram illustrating a waveform of the voltage detected by the detection unit 3. FIG. 3(b) is a diagram illustrating a waveform of the current detected by the detection unit 3. FIG. 3(c) is a diagram illustrating the RMS value of the current of FIG. 3(b). FIG. 3(d) is a diagram illustrating the first active power command value calculated by the active power command generation unit 42. FIG. 3(e) is a diagram illustrating the first reactive power command value calculated by the reactive power command generation unit 43. The first active power command value illustrated in FIG. 3(d) and the first reactive power command value illustrated in FIG. 3(e) are corrected values when the current RMS value has exceeded the current upper limit. As illustrated in FIG. 3(b), upon connection of the customer load 92 to the power converter 2, the reactive power for the reference frequency increases in the negative direction, that is, in the direction of purchasing electric power. In this situation, for example, in a case in which a portion of the customer load 92 is connected to one phase of a single-phase three-wire system, phase currents may be unbalanced, and the current RMS value may exceed a current value calculated by simply dividing the first reactive power command value provided from the external controller 98 by the voltage RMS value.

Upon exceeding of the current upper limit by the current RMS value calculated by the computation unit 41, the reactive power command generation unit 43 corrects the first reactive power command value to reduce the absolute value of the first reactive power command value to less than the value provided from the external controller 98, thus to reduce the current RMS value. In this operation, the reactive power command generation unit 43 calculates the first reactive power command value such that the average value of the current RMS value is less than or equal to the current upper limit, where the above average value is an average value of the current RMS value over the detection period T1 in which the current RMS value exceeds the current upper limit and over the mitigation period T2 in which the absolute value of the active power command value is set to a reduced value.

The order-specific reactive power computation unit 52 calculates, on the basis of the voltage and the current detected by the detection unit 3, the reactive power value for the reference frequency that varies due to connection of the customer load 92 to the power converter 2. The order-specific reactive power computation unit 52 calculates the reactive power value for the reference frequency, including the polarity thereof. For example, the order-specific reactive power computation unit 52 calculates the reactive power value for the reference frequency, including the polarity thereof that indicates a discharging or charging state. Similarly, the order-specific reactive power computation unit 52 calculates the reactive power value/values, including the polarity thereof, for the one or more multiplied frequencies.

Specifically, similarly to the case of the calculation of an active power value by the order-specific active power computation unit 51, the order-specific reactive power computation unit 52 calculates the reactive power value for the reference frequency and the reactive power value/values for the one or more multiplied frequencies by performing Fourier transform on each of the voltage detected by the detection unit 3 and the current detected by the detection unit 3 or by applying a filtering operation to attenuate values in a band other than a specific frequency band.

Similarly to the case of the calculation of an active power value by the order-specific active power computation unit 51, the upper limit of the multiplied frequencies is determined, for example, by a detection characteristic of the detection unit 3 or by a power output characteristic of the power converter 2. The detection characteristic of the detection unit 3 is a characteristic relating to, for example, accuracy or time for detection. The power output characteristic of the power converter 2 is a characteristic relating to, for example, accuracy or time for response for the output power. For example, the order-specific reactive power computation unit 52 calculates reactive power values for up to the seventh-order multiplied frequency, which is the frequency seven times as high as the reference frequency. The upper limit of the multiplied frequencies may be determined by a characteristic of the customer load 92. For example, in a case in which the customer load 92 is a capacitor compliant to JIS C 61000-3-2, the order-specific reactive power computation unit 52 calculates the reactive power values for up to the thirteenth-order multiplied frequency, which is the frequency 13 times as high as the reference frequency.

The reactive power command generation unit 43 generates the second reactive power command value for each of the reference frequency and the one or more multiplied frequencies such that the difference between each of the reactive power value for the reference frequency and the reactive power value/values for the one or more multiplied frequencies calculated by the order-specific reactive power computation unit 52 and the first reactive power command value provided from the external controller 98 is reduced. The reactive power command generation unit 43 may receive the first reactive power command value from the external controller 98 for each of the reference frequency and the one or more multiplied frequencies. The reactive power command generation unit 43 may determine that the first reactive power command value is zero for frequencies other than a specific frequency, among the first reactive power command values provided from the external controller 98, and may thus receive only the first reactive power command value for that specific frequency. One example of the specific frequency is the reference frequency.

The active power value for the reference frequency and the active power value/values for the multiplied frequency/frequencies are not varying. Thus, the active power values calculated by the order-specific active power computation unit 51 are 0 W. Considering that the first active power command value is also 0 W, the second active power command value generated by the active power command generation unit 42 is 0 W.

The drive command generation unit 44 generates a drive command on the basis of the second active power command value generated by the active power command generation unit 42 and the second reactive power command value generated by the reactive power command generation unit 43. Specifically, the drive command generation unit 44 adds the second reactive power command value generated by the reactive power command generation unit 43 to the second active power command value generated by the active power command generation unit 42 to generate the drive command. The power converter 2 operates on the basis of the drive command generated by the drive command generation unit 44. Operation of the power converter 2 based on the drive command causes the power output by the power converter 2 to follow the second active power command value generated by the active power command generation unit 42 and the second reactive power command value generated by the reactive power command generation unit 43. The power flow follows the first active power command value and the first reactive power command value provided from the external controller 98, or when the current RMS value has exceeded the current upper limit, follows the first active power command value after the correction and the first reactive power command value after the correction.

Also in a case in which the customer load 92 that is a capacitive load is disconnected from the power converter 2, in a case in which the customer load 92 is an inductive load and the customer load 92 is connected to the power converter 2, in a case in which the customer load 92 is an inductive load and the customer load 92 is disconnected from the power converter 2, and in a case in which the reactive power value for the reference frequency of the power generation apparatus 97 has changed, the power flow control method performed by the power conversion device 1 is the same as the power flow control method in the above case described with reference to FIG. 3, in which the customer load 92 that is a capacitive load is connected to the power converter 2.

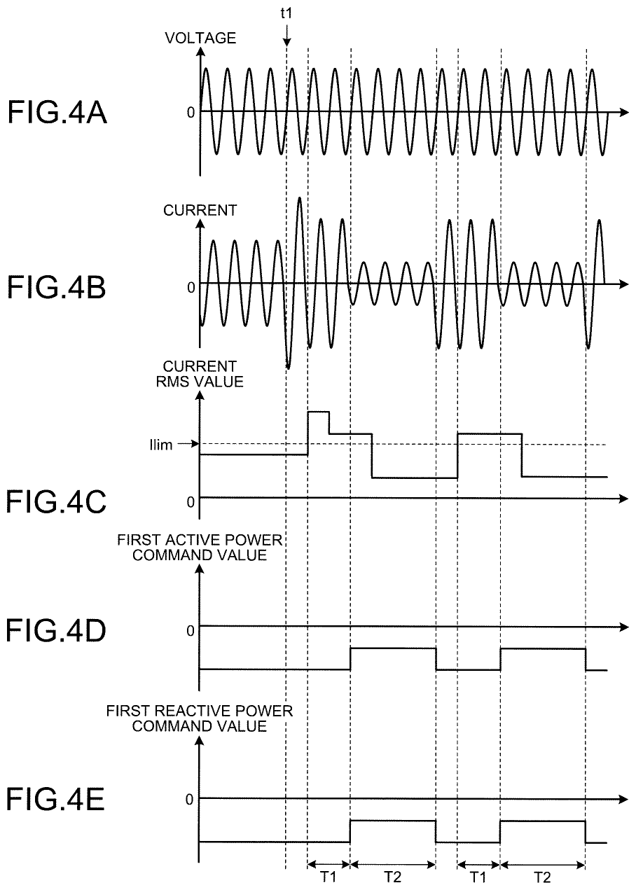

FIG. 4 is a diagram illustrating a third example of waveforms of the voltage and of the current related to the power flow and waveforms of the power flow output by the power conversion device 1 illustrated in FIG. 1. FIG. 4 illustrates an example of waveforms of the voltage and of the current related to the power flow and waveforms of the power flow under a condition in which the active power command value provided from the external controller 98 is not 0 W, the reactive power specified value is not 0 Var, the customer load 92 is a combined load of a resistive load and a capacitive load, and the customer load 92 is connected to the power converter 2 of the power conversion device 1 according to the first embodiment. A method for controlling the resultant power of the active power and the reactive power will be described below with reference to FIG. 4. Time t1 illustrated in FIG. 4 indicates the time of load application when the customer load 92 is connected to the power converter 2.

FIG. 4(a) is a diagram illustrating a waveform of the voltage detected by the detection unit 3. FIG. 4(b) is a diagram illustrating a waveform of the current detected by the detection unit 3. FIG. 4(c) is a diagram illustrating the RMS value of the current of FIG. 4(b). FIG. 4(d) is a diagram illustrating the first active power command value calculated by the active power command generation unit 42. FIG. 4(e) is a diagram illustrating the first reactive power command value calculated by the reactive power command generation unit 43. The first active power command value illustrated in FIG. 4(d) and the first reactive power command value illustrating in FIG. 4(e) are corrected values when the current RMS value has exceeded the current upper limit. As illustrated in FIG. 4(b), upon connection of the customer load 92 to the power converter 2, the active power and the reactive power for the reference frequency increase in the negative direction, that is, in the direction of purchasing electric power. In this situation, for example, in a case in which a portion of the customer load 92 is connected to one phase of a single-phase three-wire system, phase currents may be unbalanced, and the current RMS value may exceed current values calculated by simply dividing the active power command value and the reactive power command value provided from the external controller 98, each by the voltage RMS value.

Upon exceeding of the current upper limit by the current RMS value calculated by the computation unit 41, the active power command generation unit 42 and the reactive power command generation unit 43 respectively correct the first active power command value and the first reactive power command value provided from the external controller 98 to reduce the absolute values thereof, thus to reduce the current RMS value. In this operation, the active power command generation unit 42 and the reactive power command generation unit 43 respectively calculate the first active power command value and the first reactive power command value such that the average value of the current RMS value is less than or equal to the current upper limit, where the above average value is an average value of the current RMS value over the detection period T1 in which the current RMS value exceeds the current upper limit and over the mitigation period T2 in which the absolute value of the active power command value is set to a reduced value.

The order-specific active power computation unit 51 calculates, on the basis of the voltage and the current detected by the detection unit 3, the active power value for the reference frequency that varies due to connection of the customer load 92 to the power converter 2. The order-specific reactive power computation unit 52 calculates, on the basis of the voltage and the current detected by the detection unit 3, the reactive power value for the reference frequency and the reactive power value/values for the multiplied frequency/frequencies that each vary due to connection of the customer load 92 to the power converter 2. The order-specific active power computation unit 51 operates similarly to the operation of the order-specific active power computation unit 51 described with reference to FIG. 2. The order-specific reactive power computation unit 52 operates similarly to the operation of the order-specific reactive power computation unit 52 described with reference to FIG. 3.

The active power command generation unit 42 generates the second active power command value for each of the reference frequency and the one or more multiplied frequencies such that the difference between each of the active power value for the reference frequency and the active power value/values for the one or more multiplied frequencies calculated by the order-specific active power computation unit 51 and the first active power command value is reduced. The reactive power command generation unit 43 generates the second reactive power command value for each of the reference frequency and the one or more multiplied frequencies such that the difference between each of the reactive power value for the reference frequency and the reactive power value/values for the one or more multiplied frequencies calculated by the order-specific reactive power computation unit 52 and the first reactive power command value is reduced.

The drive command generation unit 44 generates a drive command on the basis of the second active power command value generated by the active power command generation unit 42 and the second reactive power command value generated by the reactive power command generation unit 43. Specifically, the drive command generation unit 44 adds the second reactive power command value generated by the reactive power command generation unit 43 to the second active power command value generated by the active power command generation unit 42 to generate the drive command. The power converter 2 operates on the basis of the drive command generated by the drive command generation unit 44. Operation of the power converter 2 based on the drive command causes the power output by the power converter 2 to follow the second active power command value generated by the active power command generation unit 42 and the second reactive power command value generated by the reactive power command generation unit 43. The power flow follows the first active power command value and the first reactive power command value provided from the external controller 98, or when the current RMS value has exceeded the current upper limit, follows the first active power command value after the correction and the first reactive power command value after the correction.

Also in a case in which the customer load 92 that is a combined load of a resistive load and a capacitive load is disconnected from the power converter 2, in a case in which the capacitive load of the customer load 92 is an inductive load and the customer load 92 is connected to the power converter 2, in a case in which the capacitive load of the customer load 92 is an inductive load and the customer load 92 is disconnected from the power converter 2, and in a case in which the active power value and the reactive power value for the reference frequency of the power generation apparatus 97 have changed, the power flow control method performed by the power conversion device 1 is the same as the power flow control method in the above case described with reference to FIG. 4, in which the customer load 92 that is a load generating a harmonic wave is connected to the power converter 2.

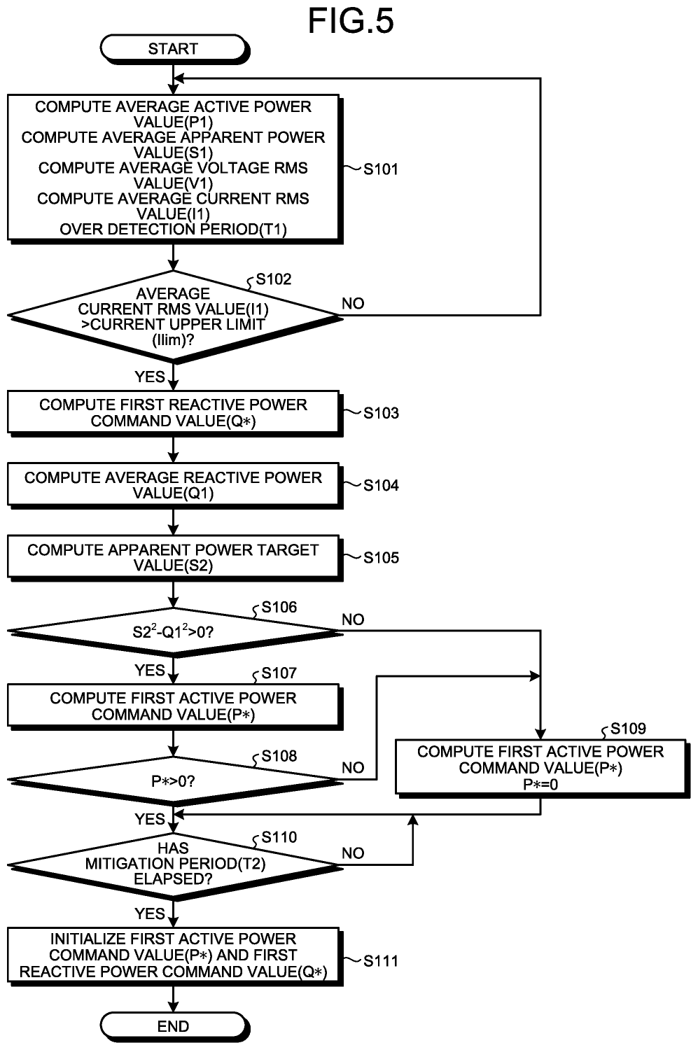

FIG. 5 is a flowchart illustrating an operation of correction of the first active power command value and the first reactive power command value performed by the control unit 4 illustrated in FIG. 1. A method for correcting the first active power command value and the first reactive power command value under a condition in which the current RMS value has exceeded the current upper limit will next be described with reference to FIG. 5. Note that this method is not intended to limit the scope of this invention, but a control method such as, for example, feedback control of the first active power command value and of the first reactive power command value to limit the current RMS value to a value at or below a current upper limit is also within the scope of this invention.

The control unit 4 first calculates an average active power value P1, an average apparent power value S1, an average voltage RMS value V1, and an average current RMS value I1, which are respectively the average values, over the detection period T1, of the active power value, the apparent power value, the voltage RMS value, and the current RMS value, each calculated by the computation unit 41, on the basis of the voltage detected by the detection unit 3 and the current detected by the detection unit 3 (step S101). The method for calculating an average value may be a zone average over the detection period T1 or a moving average over the detection period T1. Note that, the average values for a system such as, for example, a single-phase three-wire system or a three-phase three-wire system may be computed on a per-phase basis.

The control unit 4 determines whether the average current RMS value I1 calculated is greater than a current upper limit Ilim (step S102). If the average current RMS value I1 is greater than the current upper limit Ilim (step S102: Yes), the control unit 4 computes the first active power command value and the first reactive power command value (step S103). Otherwise, if the average current RMS value I1 is not greater than the current upper limit Ilim (step S102: No), the control unit 4 repeats the operation at step S101.

The control unit 4 sets the first reactive power command value Q* for the mitigation period T2 to 0 Var. To simplify the calculation of the first active power command value P* and of the first reactive power command value Q*, the control unit 4 may fixedly set the first reactive power command value Q* to 0 Var and calculate only the first active power command value P* or may otherwise fixedly set the first active power command value P* to 0 W and calculate only the first reactive power command value Q*.

The control unit 4 computes the average reactive power value Q1 over the detection period T1 (step S104). The control unit 4 can calculate the average reactive power value Q1 on the basis of the average apparent power value S1 and the average active power value P1 using Formula (1) below.

[Formula 1]

Q1=\sqrt{(S1²−P1²)} (1)

The control unit 4 computes an apparent power target value S2 in the mitigation period T2 (step S105). Setting of the apparent power target value S2 to cause the average current RMS value over the entire period of both the detection period T1 and the mitigation period T2 to be the current upper limit Ilim enables the apparent power target value S2 to be calculated on the basis of the average apparent power value S1, the average voltage RMS value V1, the current upper limit Ilim, the detection period T1, and the mitigation period T2 using Formula (2) below. Note that the apparent power target value S2 may be set such that the average current RMS value over the entire period is less than the current upper limit Ilim while ensuring a sufficient gap between the average current RMS value over the entire period and the current upper limit Ilim.

$$\begin{matrix}[ Formula 2 ] & \\ S 2 = \frac{( V 1 \times I lim ) \times ( T 1 + T 2 )}{T 2 ( S 1 \times T 1 )} & ( 2 )\end{matrix}$$

The control unit 4 then determines whether S2²−Q1² results in a positive value (step S106). The operation at step S106 is performed to determine whether the first active power command value P* will not be a complex number. If S2²−Q1² does not result in a positive value (step S106: No), the control unit 4 sets the first active power command value P* in the mitigation period T2 to 0 W, which is the lower limit (step S109).

If S2²−Q1² results in a positive value (step S106: Yes), the control unit 4 computes the first active power command value P* in the mitigation period T2 (step S107). It is assumed, for example, that the customer loads are mostly located on one phase of a three-phase three-wire system and a decrease in the first active power command value P* causes the current RMS value of that phase only to decrease to half. In addition, setting the first reactive power command value Q* to 0 Var at step S103 should reduce the reactive power value in the mitigation period T2 to a value less than the average reactive power value Q1 over the detection period T1. However, assuming that the reactive power value does not change from the average reactive power value Q1 over the detection period T1, the first active power command value P* can be calculated on the basis of the average active power value P1, the average reactive power value Q1, and the apparent power target value S2 using Formula (3) below.

$$\begin{matrix}[ Formula 3 ] & \\ S {2}^{2} = {( P 1 - \frac{Δ P}{2} )}^{2} + Q {1}^{2} \\ Δ P = 2 \times P 1 - 2 \times \sqrt{S {2}^{2} - Q {1}^{2}} \\ {P}^{*} = P 1 - Δ P = - P 1 - 2 \times \sqrt{( S {2}^{2} - Q {1}^{2} )} & ( 3 )\end{matrix}$$

The control unit 4 determines whether the first active power command value P* in the mitigation period T2 is greater than 0 (step S108). If the first active power command value P* calculated at step S107 is 0 or less (step S108: No), the control unit 4 sets the first active power command value “P*” in the mitigation period T2 to 0 W, which is the lower limit (step S109).

If the first active power command value P* calculated at step S107 is greater than 0 (step S108: Yes) or after the first active power command value P* is set to 0 W, which is the lower limit, the control unit 4 determines whether the mitigation period T2 has elapsed since the first active power command value P* and the first reactive power command value Q* for the mitigation period T2 are set (step S110). If the mitigation period T2 has already elapsed (step S110: Yes), the control unit 4 sets the first active power command value P* and the first reactive power command value Q* respectively back to the first active power command value P* before the correction and the first reactive power command value Q* before the correction, each provided from the external controller 98 (step S111). However, there may be a case in which the second active power command value generated by the active power command generation unit 42 is limited by the active power limiter 53 and the second reactive power command value generated by the reactive power command generation unit 43 is limited by the reactive power limiter 54, thereby preventing the power flow from following the first active power command value P* and the first reactive power command value Q*. Thus, the operation may be performed such that it is determined whether the average current RMS value over the entire period of both the detection period T1 and the mitigation period T2 is greater than the current upper limit Ilim, and if the average current RMS value over the entire period is greater than the current upper limit Ilim, then the first active power command value P* is maintained. Moreover, if the average current RMS value over the entire period remains greater than the current upper limit Ilim for a certain time period, the power converter 2 may be driven to stop the power output.

The power converter 2 cannot output power whose apparent power exceeds an upper limit. As described above, the control unit 4 includes the active power limiter 53 and the reactive power limiter 54. In a case in which the power converter 2 assigns a priority to outputting of the active power, the active power limiter 53 operates and the reactive power limiter 54 does not operate. In a case in which the power converter 2 assigns a priority to outputting of the reactive power, the reactive power limiter 54 operates and the active power limiter 53 does not operate.

In a case in which the power converter 2 assigns a priority to outputting of the active power, the active power limiter 53 sets an upper limit of the second active power command value, i.e., a first configurable upper limit, to a value Plim given using Formula (4) below. The case in which the power converter 2 assigns a priority to outputting of the active power is a case in which the operation of following the second active power command value is given higher priority than the operation of following the second reactive power command value. In Formula (4), Plim represents the first configurable upper limit set by the active power limiter 53 and Slim represents the upper limit of the apparent power.

[Formula 4]

Plim=Slim (4)

That is, the second active power command value generated by the active power command generation unit 42 is limited to less than or equal to the value Plim given by Formula (4).

In a case in which the power converter 2 assigns a priority to outputting of the active power, the reactive power limiter 54 computes a value Qlim given using Formula (5) below, and sets an upper limit of the second reactive power command value, i.e., a second configurable upper limit, to the value Qlim given using Formula (5). In Formula (5), Qlim represents the second configurable upper limit set by the reactive power limiter 54 and Pref represents the first active power command value provided from the external controller 98.

[Formula 5]

Qlim=\sqrt{Slim²−Pref²} (5)

That is, the second reactive power command value generated by the reactive power command generation unit 43 is limited to less than or equal to the value Qlim given by Formula (5).

To prevent the power converter 2 from outputting power whose apparent power exceeds an upper limit, the computing operation is sequentially performed in order of the first operation, the second operation, and the third operation described below.

First operation: operation performed by the active power command generation unit 42

Second operation: operation of calculating Qlim by the reactive power limiter 54

Third operation: operation performed by the reactive power command generation unit 43

In a case in which the power converter 2 assigns a priority to outputting of the reactive power, the reactive power limiter 54 sets an upper limit of the second reactive power command value, i.e., a third configurable upper limit, to a value Qlim given using Formula (6) below. The case in which the power converter 2 assigns a priority to outputting of the reactive power is a case in which the operation of following the second reactive power command value is given higher priority than the operation of following the second active power command value. In Formula (6), Qlim represents the third configurable upper limit set by the reactive power limiter 54 and Slim represents the upper limit of the apparent power.

[Formula 6]

Qlim=Slim (6)

That is, the second reactive power command value generated by the reactive power command generation unit 43 is limited to less than or equal to the value Qlim given by Formula (6).

In a case in which the power converter 2 assigns a priority to outputting of the reactive power, the active power limiter 53 computes a value Plim given by Formula (7) below, and sets an upper limit of the second active power command value, i.e., a fourth configurable upper limit, to the value Plim given by Formula (7). In Formula (7), Plim represents the fourth configurable upper limit set by the active power limiter 53 and Qref represents the first reactive power command value provided from the external controller 98.

[Formula 7]

Plim=\sqrt{Slimⁿ−Qref²} (7)

That is, the second active power command value generated by the active power command generation unit 42 is limited to less than or equal to the value Plim given by Formula (7).

To prevent the power converter 2 from outputting power whose apparent power exceeds an upper limit, the computing operation is sequentially performed in order of the fourth operation, the fifth operation, and the sixth operation described below.

Fourth operation: operation performed by the reactive power command generation unit 43

Fifth operation: operation of calculating “Plim” by the active power limiter 53

Sixth operation: operation performed by the active power command generation unit 42

As described above, the power conversion device 1 according to the first embodiment is connected with the electrical storage device 91, and the power conversion device 1 has a function to convert DC power stored in the electrical storage device 91 to AC power. The power conversion device 1 is also connected with the customer load 92 and with the power system 93, and the power conversion device 1 has a function to output the AC power generated by the conversion to one or both of the customer load 92 and the power system 93. The power conversion device 1 is also connected with the external controller 98. The external controller 98 provides an active power command value and a reactive power command value to the power conversion device 1.

Under a condition in which the electrical storage device 91, the customer load 92, the power system 93, and the external controller 98 are connected to the power conversion device 1, the power conversion device 1 detects the voltage and the current at the first location 95 of the power line 94 connecting together the power converter 2 and the power system 93, where the power converter 2 has the function to convert DC power stored in the electrical storage device 91 to AC power, and the power conversion device 1 generates a drive command for controlling the power converter 2 on the basis of the voltage and the current detected as well as the active power command value and the reactive power command value each provided from the external controller 98. The power converter 2 operates on the basis of the drive command generated. Thus, the power conversion device 1 provides an advantage in that power can be output while taking into consideration the power output from the electrical storage device 91 connected, the power consumption of the customer load 92, and the first active power command value and the first reactive power command value provided from the external controller 98.

In more detail, under a condition in which the electrical storage device 91 and the customer load 92 are connected to the power conversion device 1, the power conversion device 1 can cause the power flow between the power conversion device 1 and the power system 93 to follow the first active power command value and the first reactive power command value each provided from the external controller 98. This enables the power conversion device 1 to supply, to the power system 93, active power and reactive power needed for the entire power distribution system.

The power conversion device 1 includes the active power limiter 53 and the reactive power limiter 54. This configuration causes the second active power command value and the second reactive power command value that lead to the drive command to become values that prevent the power converter 2 from outputting power whose apparent power exceeds an upper limit. This enables the power conversion device 1 to avoid a situation requiring outputting of power whose apparent power exceeds an upper limit, thereby reducing or eliminating the possibility of occurrence of an abnormal condition in the power conversion device 1.

In the first embodiment described above, the drive command generation unit 44 included in the control unit 4 generates the drive command on the basis of the second active power command value generated by the active power command generation unit 42 and the second reactive power command value generated by the reactive power command generation unit 43. However, the drive command generation unit 44 may generate the drive command on the basis of one of the second active power command value generated by the active power command generation unit 42 and the second reactive power command value generated by the reactive power command generation unit 43. That is, the drive command generation unit 44 generates the drive command on the basis of one or both of the second active power command value generated by the active power command generation unit 42 and the second reactive power command value generated by the reactive power command generation unit 43.

In a case in which the drive command generation unit 44 generates the drive command on the basis of the second active power command value generated by the active power command generation unit 42, the power conversion device 1 provides an advantage in that power can be output while taking into consideration the power output from the electrical storage device 91 connected, the power consumption of the customer load 92, and the first active power command value provided from the external controller 98. In a case in which the drive command generation unit 44 generates the drive command on the basis of the second reactive power command value generated by the reactive power command generation unit 43, the power conversion device 1 provides an advantage in that power can be output while taking into consideration the power output from the electrical storage device 91, the power consumption of the customer load 92, and the first reactive power command value provided from the external controller 98. In addition, the active power command generation unit 42 and the reactive power command generation unit 43 are capable of respectively correcting the first active power command value and the first reactive power command value on the basis of the current RMS value of the power flow current supplied to the power system 93 and the rated current of the molded case circuit breaker 99 connected between the power converter 2 and the power system 93. This feature enables the control unit 4 to control the power converter 2 on the basis of the current RMS value of the power flow current supplied to the power system 93 and the rated current of the molded case circuit breaker 99 connected between the power converter 2 and the power system 93. Thus, power can be output such that opening of the molded case circuit breaker 99 is prevented.

Moreover, in the first embodiment described above, the computation unit 41 included in the control unit 4 calculates the active power value and the reactive power value of the power flow on the basis of the voltage and the current detected by the detection unit 3. As long as the active power value and the reactive power value of the power flow can be successfully calculated, the computation unit 41 may calculate the active power value and the reactive power value of the power flow on the basis of part or all of the power output by the electrical storage device 91, the power output by the power converter 2, the power consumed in the customer load 92, and the power output by the power generation apparatus 97.

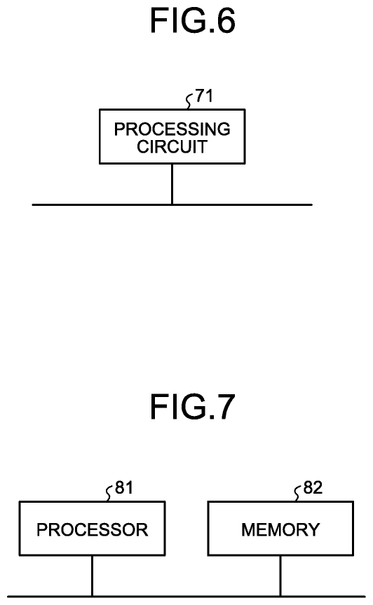

FIG. 6 is a diagram illustrating a processing circuit 71 for implementing at least part of the function of the detection unit 3 and of the control unit 4 included in the power conversion device 1 according to the first embodiment. That is, at least part of the function of the detection unit 3 and of the control unit 4 may be implemented in the processing circuit 71. In more detail, at least part of the function of the order-specific active power computation unit 51 and the order-specific reactive power computation unit 52 included in the computation unit 41 and of the computation unit 41, the active power command generation unit 42, the reactive power command generation unit 43, the drive command generation unit 44, the active power limiter 53, and the reactive power limiter 54 included in the control unit 4 may be implemented in the processing circuit 71.

The processing circuit 71 is a dedicated hardware element. The processing circuit 71 is, for example, a single circuit, a composite circuit, a programmed processor, a parallel programmed processor, an application specific integrated circuit (ASIC), a field-programmable gate array (FPGA), or a combination thereof. The detection unit 3 and the control unit 4 may be implemented partly in a dedicated hardware element separate from the remainder. In more detail, the order-specific active power computation unit 51, the order-specific reactive power computation unit 52, the current RMS value computation unit 57, the computation unit 41, the active power command generation unit 42, the reactive power command generation unit 43, the drive command generation unit 44, the active power limiter 53, and the reactive power limiter 54 may be implemented partly in a dedicated hardware element separate from the remainder.

FIG. 7 is a diagram illustrating a processor 81 for implementing at least part of the function of the detection unit 3 and of the control unit 4 included in the power conversion device 1 according to the first embodiment. That is, at least part of the function of the detection unit 3 and of the control unit 4 included in the power conversion device 1 may be implemented in the processor 81 that executes a program stored in a memory 82.

In more detail, at least part of the function of the order-specific active power computation unit 51, the order-specific reactive power computation unit 52, the current RMS value computation unit 57, the computation unit 41, the active power command generation unit 42, the reactive power command generation unit 43, the drive command generation unit 44, the active power limiter 53, and the reactive power limiter 54 may be implemented in the processor 81 that executes a program stored in the memory 82. The processor 81 is a central processing unit (CPU), a processing unit, a computing unit, a microprocessor, a microcomputer, or a digital signal processor (DSP). FIG. 7 also illustrates the memory 82.

In a case in which at least part of the function of the detection unit 3 and of the control unit 4 is implemented in the processor 81, that part of the function is implemented in the processor 81 and software, firmware, or a combination of software and firmware. In more detail, in a case in which at least part of the function of the order-specific active power computation unit 51, the order-specific reactive power computation unit 52, the current RMS value computation unit 57, the computation unit 41, the active power command generation unit 42, the reactive power command generation unit 43, the drive command generation unit 44, the active power limiter 53, and the reactive power limiter 54 is implemented in the processor 81, that part of the function is implemented in the processor 81 and software, firmware, or a combination of software and firmware.

The software or firmware is described as a program and is stored in the memory 82. The processor 81 reads and executes a program stored in the memory 82, and thus implements at least part of the function of the detection unit 3 and of the control unit 4. In more detail, the processor 81 reads and executes a program stored in the memory 82, and thus implements at least part of the function of the order-specific active power computation unit 51, the order-specific reactive power computation unit 52, the current RMS value computation unit 57, the computation unit 41, the active power command generation unit 42, the reactive power command generation unit 43, the drive command generation unit 44, the active power limiter 53, and the reactive power limiter 54.

That is, in a case in which at least part of the function of the detection unit 3 and of the control unit 4 is implemented in the processor 81, the power conversion device 1 includes the memory 82 for storing a program that causes the processor 81 to perform steps to be performed by at least part of the detection unit 3 and the control unit 4.

In more detail, in a case in which at least part of the function of the order-specific active power computation unit 51, the order-specific reactive power computation unit 52, the current RMS value computation unit 57, the computation unit 41, the active power command generation unit 42, the reactive power command generation unit 43, the drive command generation unit 44, the active power limiter 53, and the reactive power limiter 54 is implemented in the processor 81, the power conversion device 1 includes the memory 82 for storing a program that causes the processor 81 to perform steps to be performed by at least part of the order-specific active power computation unit 51, the order-specific reactive power computation unit 52, the current RMS value computation unit 57, the computation unit 41, the active power command generation unit 42, the reactive power command generation unit 43, the drive command generation unit 44, the active power limiter 53, and the reactive power limiter 54.

A program stored in the memory 82 can also be said to be a program that causes a computer to perform a method or procedure to be performed by at least part of the detection unit 3 and the control unit 4. In more detail, a program stored in the memory 82 can also be said to be a program that causes a computer to perform a method or procedure to be performed by at least part of the order-specific active power computation unit 51, the order-specific reactive power computation unit 52, the current RMS value computation unit 57, the computation unit 41, the active power command generation unit 42, the reactive power command generation unit 43, the drive command generation unit 44, the active power limiter 53, and the reactive power limiter 54.

The memory 82 is, for example, a non-volatile or volatile semiconductor memory, such as a random access memory (RAM), a read-only memory (ROM), a flash memory, an erasable programmable read-only memory (EPROM), or an electrically erasable programmable read-only memory (EEPROM) (trademark), a magnetic disk, a flexible disk, an optical disk, a compact disc, a MiniDisc, a digital versatile disk (DVD), or the like.

Multiple functions of the detection unit 3 and of the control unit 4 may be implemented partly in a dedicated hardware element, and the remainder of the multiple functions may be implemented in software or firmware. Thus, multiple functions of the detection unit 3 and of the control unit 4 can be implemented in hardware, software, firmware, or a combination thereof.

In more detail, multiple functions of the order-specific active power computation unit 51, the order-specific reactive power computation unit 52, the current RMS value computation unit 57, the computation unit 41, the active power command generation unit 42, the reactive power command generation unit 43, the drive command generation unit 44, the active power limiter 53, and the reactive power limiter 54 may be implemented partly in a dedicated hardware element, and the remainder of the multiple functions may be implemented in software or firmware. Thus, multiple functions of the order-specific active power computation unit 51, the order-specific reactive power computation unit 52, the current RMS value computation unit 57, the computation unit 41, the active power command generation unit 42, the reactive power command generation unit 43, the drive command generation unit 44, the active power limiter 53, and the reactive power limiter 54 can be implemented in hardware, software, firmware, or a combination thereof.

### Second Embodiment

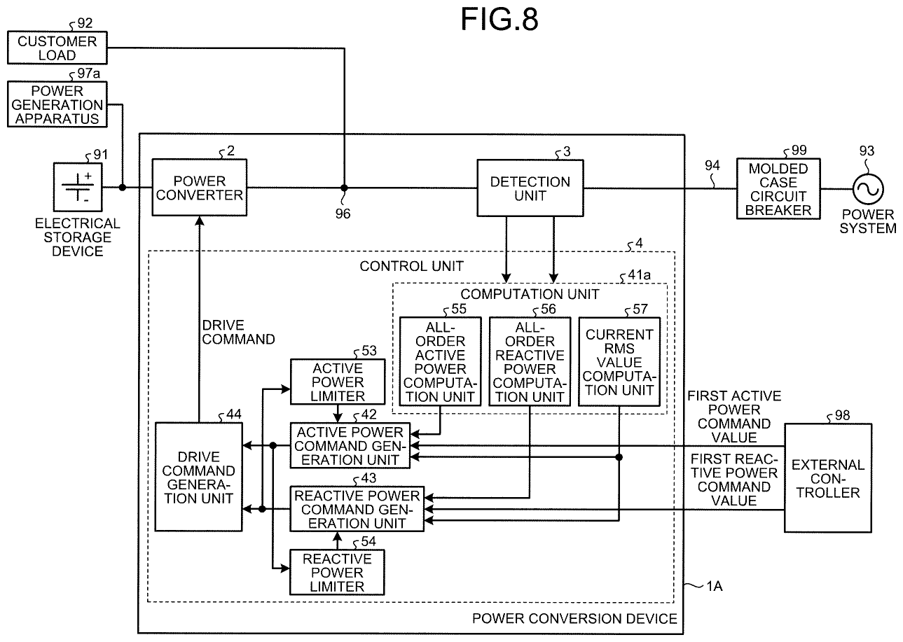

A power conversion device 1A according to a second embodiment will next be described. FIG. 8 is a diagram illustrating a configuration of the power conversion device 1A according to the second embodiment of the present invention. As is apparent from a comparison of the FIG. 8 for the second embodiment with FIG. 1 for the first embodiment, the power conversion device 1A includes all of the components included in the power conversion device 1 according to the first embodiment except the order-specific active power computation unit 51 and the order-specific reactive power computation unit 52. The power conversion device 1A includes an all-order active power computation unit 55 and an all-order reactive power computation unit 56 in place of the order-specific active power computation unit 51 and the order-specific reactive power computation unit 52. The power conversion device 1A includes, in place of the computation unit 41 of the power conversion device 1, a computation unit 41a including the all-order active power computation unit 55 and the all-order reactive power computation unit 56. In the second embodiment, a power generation apparatus 97a is not connected to the power line 94. The second embodiment will be mainly described in terms of differences from the first embodiment.

In the second embodiment, the power converter 2 is connected with the power generation apparatus 97a that generates DC power, such that the power generation apparatus 97a is in parallel with the electrical storage device 91. For example, the power generation apparatus 97a is a device that generates DC power by means of solar power generation. The power converter 2 also has a function to convert DC power, generated by the electrical storage device 91 and by the power generation apparatus 97a, to AC power and a function to output the AC power based on the DC power generated by the electrical storage device 91 and by the power generation apparatus 97a, to the customer load 92 and the power system 93. Note that the configuration may be such that only one of the electrical storage device 91 and the power generation apparatus 97a is connected to the power converter 2. In addition, the power generation apparatus 97a may be connected to the power converter 2 included in the power conversion device 1 according to the first embodiment, such that the power generation apparatus 97a is in parallel with the electrical storage device 91.

The all-order active power computation unit 55 calculates, on the basis of the voltage and the current detected by the detection unit 3, an all-order active power value, which is a sum of the active power value for the reference frequency and the active power value/values for one or more multiplied frequencies, where the one or more multiplied frequencies are products of the foregoing frequency and respective numbers from 2 to a predetermined integer greater than or equal to 2. That is, the all-order active power computation unit 55 is a second active power computation unit that calculates an all-order active power value, which is a sum of the active power value for the reference frequency of the AC power of the power system 93 and the active power value/values for the one or more multiplied frequencies based on the reference frequency. The all-order reactive power computation unit 56 calculates, on the basis of the voltage and the current detected by the detection unit 3, an all-order reactive power value, which is a sum of the reactive power value for the frequency of the AC power of the power system 93 and the reactive power value/values for one or more multiplied frequencies, where the one or more multiplied frequencies are products of the foregoing frequency and respective numbers from 2 to a predetermined integer greater than or equal to 2. That is, the all-order reactive power computation unit 56 is a second reactive power computation unit that calculate an all-order reactive power value, which is a sum of the reactive power value for the frequency of the AC power of the power system 93 and the reactive power value/values for the one or more multiplied frequencies based on the foregoing frequency. The foregoing frequency is the reference frequency.

The active power command generation unit 42 generates the second active power command value on the basis of the first active power command value provided from the external controller 98 and the all-order active power value calculated by the all-order active power computation unit 55. Specifically, to reduce the difference between the first active power command value and the all-order active power value calculated by the all-order active power computation unit 55, the active power command generation unit 42 subtracts the all-order active power value from the active power command value to calculate a deviation, provides control, such as PI control, to reduce this deviation, and thus generates the second active power command value.

The reactive power command generation unit 43 generates the second reactive power command value on the basis of the first reactive power command value provided from the external controller 98 and the all-order reactive power value calculated by the all-order reactive power computation unit 56. Specifically, to reduce the difference between the first reactive power command value and the all-order reactive power value calculated by the all-order reactive power computation unit 56, the reactive power command generation unit 43 subtracts the all-order reactive power value from the reactive power command value to calculate a deviation, provides control, such as PI control, to reduce this deviation, and thus generates the second reactive power command value.

A main difference between the second embodiment and the first embodiment exists in that the power conversion device 1A according to the second embodiment includes the all-order active power computation unit 55 and the all-order reactive power computation unit 56 in place of the order-specific active power computation unit 51 and the order-specific reactive power computation unit 52 included in the power conversion device 1 according to the first embodiment. The power conversion device 1 according to the first embodiment is configured to individually control the active power value for the reference frequency, the active power value/values for the multiplied frequency/frequencies, the reactive power value for the reference frequency, and the reactive power value/values for the multiplied frequency/frequencies. In contrast, the power conversion device 1A according to the second embodiment is configured to control the all-order active power value, which is a sum of the active power value for the reference frequency and the active power value/values for the one or more multiplied frequencies, and the all-order reactive power value, which is a sum of the reactive power value for the reference frequency and the reactive power value/values for the one or more multiplied frequencies.

The power conversion device 1A detects a voltage and a current at the first location 95 of the power line 94 connecting together the power converter 2 and the power system 93 to generate a drive command for controlling the power converter 2 on the basis of the voltage and the current detected and of the first active power command value and the first reactive power command value provided from the external controller 98. The power conversion device 1A provides an advantage in that power can be output while taking into consideration the power output from the electrical storage device 91 connected, the power consumption of the customer load 92, and the first active power command value and the first reactive power command value each provided from the external controller 98. In more detail, the power conversion device 1A can cause the power flow to follow the first active power command value and the first reactive power command value each provided from the external controller 98. This enables the power conversion device 1A to supply, to the power system 93, active power and reactive power needed for the entire power distribution system.

The power conversion device 1A includes the active power limiter 53 and the reactive power limiter 54. This configuration causes the second active power command value and the second reactive power command value that lead to the drive command to become values that prevent the power converter 2 from outputting power whose apparent power exceeds an upper limit. This enables the power conversion device 1A to avoid a situation requiring outputting of power whose apparent power exceeds an upper limit, thereby reducing or eliminating the possibility of occurrence of an abnormal condition in the power conversion device 1A.

As described above, the power conversion device 1A according to the second embodiment includes the all-order active power computation unit 55 and the all-order reactive power computation unit 56 in place of the order-specific active power computation unit 51 and the order-specific reactive power computation unit 52 included in the power conversion device 1 according to the first embodiment. The all-order active power computation unit 55 and the all-order reactive power computation unit 56 calculate the all-order active power value or the all-order reactive power value instead of calculating the active power values or the reactive power value for multiple multiplied frequencies, and can therefore calculate an active power value or a reactive power value more easily than the order-specific active power computation unit 51 and the order-specific reactive power computation unit 52.

Part or all of the all-order active power computation unit 55 and the all-order reactive power computation unit 56 may be implemented in a processing circuit having the same function as the function of the processing circuit 71 described in the first embodiment. At least part of the function of the all-order active power computation unit 55 and of the all-order reactive power computation unit 56 may be implemented in a processor having the same function as the function of the processor 81 described in the first embodiment. In a case in which at least part of the function of the all-order active power computation unit 55 and of the all-order reactive power computation unit 56 is implemented in the processor, the power conversion device 1A includes a memory for storing a program that causes the processor to perform steps to be performed by at least part of the all-order active power computation unit 55 and the all-order reactive power computation unit 56. The memory is a memory having the same function as the function of the memory 82 described in the first embodiment.

Also in the second embodiment, the power generation apparatus 97 described in the first embodiment may be connected to the second location 96 located between the power converter 2 and the first location 95 of the power line 94.

The configurations described in the foregoing embodiments are merely examples of various aspects of the present invention. These configurations may be combined with a known other technology, and moreover, part of such configurations may be omitted and/or modified without departing from the spirit of the present invention.

### REFERENCE SIGNS LIST

1, 1A power conversion device; 2 power converter; 3 detection unit; 4 control unit; 41, 41a computation unit; 42 active power command generation unit; reactive power command generation unit; 44 drive command generation unit; 51 order-specific active power computation unit; 52 order-specific reactive power computation unit; 53 active power limiter; 54 reactive power limiter; 55 all-order active power computation unit; all-order reactive power computation unit; 57 current RMS value computation unit; 71 processing circuit; 81 processor; 82 memory; 91 electrical storage device; 92 customer load; 93 power system; 94 power line; 95 first location; 96 second location; 97, 97a power generation apparatus; 98 external controller; 99 molded case circuit breaker.

1-10. (canceled)

11. A power conversion device comprising:
a power converter connected to an electrical storage device that stores direct current power, the power converter being capable of converting the direct current power stored in the electrical storage device to alternating current power and outputting the alternating current power to a power system and to a customer load;
a detector to detect a power flow current between the power converter and the power system;
a first active power calculator to calculate, on a basis of the detection result of the detector, an active power value for a reference frequency that is a frequency of an alternating current of the power system and an active power value for a multiplied frequency based on the reference frequency,
a first reactive power calculator to calculate, on a basis of the detection result of the detector, a reactive power value for the reference frequency and a reactive power value for the multiplied frequency based on the reference frequency,
an active power command generator to generate a second active power command value on a basis of a first active power command value provided from an external controller and of at least one of the active power value for the reference frequency or the active power value for the multiplied frequency calculated by the first active power calculator, in a case in which a current root-mean-square value of a power flow current supplied to the power system is greater than a current upper limit that is set on a basis of a rated current of a molded case circuit breaker connected between the power converter and the power system, to correct the first active power command value, and to generate the second active power command value using the first active power command value after the correction,
a reactive power command generator to generate a second reactive power command value on a basis of a first reactive power command value provided from the external controller and of at least one of the reactive power value for the reference frequency or the reactive power value for the multiplied frequency calculated by the first reactive power calculator, in a case in which the current root-mean-square value is greater than the current upper limit, to correct the first reactive power command value, and to generate the second reactive power command value using the first reactive power command value after the correction, and
a drive command generator to generate a drive command for controlling the power converter, on a basis of at least one of the second active power command value or the second reactive power command value.

12. A power conversion device comprising:
a power converter connected to an electrical storage device that stores direct current power, the power converter being capable of converting the direct current power stored in the electrical storage device to alternating current power and outputting the alternating current power to a power system and to a customer load;
a detector to detect a power flow current between the power converter and the power system;
a second active power calculator to calculate, on a basis of the detection result of the detector, an all-order active power value that is a sum of an active power value for a frequency of an alternating current of the power system and an active power value for a multiplied frequency based on the frequency,
a second reactive power calculator to calculate, on a basis of the detection result of the detector, an all-order reactive power value that is a sum of a reactive power value for the frequency of the alternating current of the power system and a reactive power value for the multiplied frequency based on the frequency,
an active power command generator to generate a second active power command value on a basis of a first active power command value provided from an external controller and the all-order active power value, in a case in which a current root-mean-square value of a power flow current supplied to the power system is greater than a current upper limit that is set on a basis of a rated current of a molded case circuit breaker connected between the power converter and the power system, to correct the first active power command value, and to generate the second active power command value using the first active power command value after the correction,
a reactive power command generator to generate a second reactive power command value on a basis of a first reactive power command value provided from the external controller and the all-order reactive power value, in a case in which the current root-mean-square value is greater than the current upper limit, to correct the first reactive power command value, and to generate the second reactive power command value using the first reactive power command value after the correction, and
a drive command generator to generate a drive command for controlling the power converter, on a basis of at least one of the second active power command value or the second reactive power command value.

13. The power conversion device according to claim 11, further comprising an active power limiter to set an upper limit of the second active power command value on a basis of the first reactive power command value and an upper limit of an apparent power that the power converter is allowed to output, and
the active power command generator generates the second active power command value that is less than or equal to the upper limit that is set by the active power limiter.

14. The power conversion device according to claim 11, further comprising a reactive power limiter to set an upper limit of the second reactive power command value on a basis of the first active power command value and an upper limit of an apparent power that the power converter is allowed to output, and
the reactive power command generator generates the second reactive power command value that is less than or equal to the upper limit that is set by the reactive power limiter.

15. The power conversion device according to claim 11, wherein
after the correction of the first active power command value, when the current root-mean-square value falls below the current upper limit, the active power command generator sets the first active power command value back to a value before the correction, and
after the correction of the first reactive power command value, when the current root-mean-square value falls below the current upper limit, the reactive power command generator sets the first reactive power command value back to a value before the correction.

16. The power conversion device according to claim 11, wherein a power generation apparatus that outputs alternating current power is connected between the power converter and the molded case circuit breaker.

17. The power conversion device according to claim 11, wherein
the power converter is connected with a power generation apparatus that generates direct current power, such that the power generation apparatus is in parallel with the electrical storage device, and
the power converter further has a function to convert the direct current power generated by the power generation apparatus to alternating current power.

18. The power conversion device according to claim 11, wherein the power converter stops outputting the alternating current power when the current root-mean-square value exceeds the current upper limit for a predetermined time period.

19. The power conversion device according to claim 12 further comprising an active power limiter to set an upper limit of the second active power command value on a basis of the first reactive power command value and an upper limit of an apparent power that the power converter is allowed to output, and
the active power command generator generates the second active power command value that is less than or equal to the upper limit that is set by the active power limiter.

20. The power conversion device according to claim 12, further comprising a reactive power limiter to set an upper limit of the second reactive power command value on a basis of the first active power command value and an upper limit of an apparent power that the power converter is allowed to output, and
the reactive power command generator generates the second reactive power command value that is less than or equal to the upper limit that is set by the reactive power limiter.

21. The power conversion device according to claim 12, wherein
after the correction of the first active power command value, when the current root-mean-square value falls below the current upper limit, the active power command generator sets the first active power command value back to a value before the correction, and
after the correction of the first reactive power command value, when the current root-mean-square value falls below the current upper limit, the reactive power command generator sets the first reactive power command value back to a value before the correction.

22. The power conversion device according to claim 12, wherein a power generation apparatus that outputs alternating current power is connected between the power converter and the molded case circuit breaker.

23. The power conversion device according to claim 12, wherein
the power converter is connected with a power generation apparatus that generates direct current power, such that the power generation apparatus is in parallel with the electrical storage device, and
the power converter further has a function to convert the direct current power generated by the power generation apparatus to alternating current power.

24. The power conversion device according to claim 12, wherein the power converter stops outputting the alternating current power when the current root-mean-square value exceeds the current upper limit for a predetermined time period.
